(19) United States
(12) Patent Application Publication
(10) Pub. No.: US 2016/0357672 A1
(43) Pub. Date: Dec. 8, 2016

(54) METHODS AND APPARATUS FOR ATOMIC WRITE PROCESSING

(71) Applicant: HITACHI, LTD., Tokyo (JP)

(72) Inventors: Akira DEGUCHI, Santa Clara, CA (US); Akio NAKAJIMA, Santa Clara, CA (US)

(21) Appl. No.: 15/226,695

(22) Filed: Aug. 2, 2016

Related U.S. Application Data
(63) Continuation of application No. 13/897,188, filed on May 17, 2013, now abandoned.

(51) Int. Cl. G06F 12/0804; G06F 3/06; G06F 12/1009

(52) U.S. Cl. CPC G06F 12/0804; G06F 12/1009; G06F 3/0619; G06F 3/0659; G06F 3/0685

(57) ABSTRACT

Example implementations described herein are directed to implementation of the atomic write feature in the storage system setting. Example implementations may utilize flash memory to facilitate or to form atomic write commands to improve flash memory performance and endurance. Several protocols involving the cache unit of the storage system may include managing a status of the storage system so that data corresponding to an atomic write command are stored in a cache unit, with old data maintained in the storage system until the write data corresponding to an atomic write command is properly received.

### CROSS REFERENCE TO RELATED APPLICATIONS

The application is a continuation of U.S. application Ser. No. 13/897,188, filed on May 17, 2013, the disclosure of which is incorporated by reference in its entirety for all purposes.

### BACKGROUND

Field

The present application is generally related to storage systems and, more specifically, to input/output (I/O) processing methods of storage systems.

Related Art

The atomic write operation is used in the related art for the purpose of reducing overhead in the OS or middleware and the number of I/Os to the flash memory.

Atomic write reduces the number of write operations by bundling two or more write operations into one write operation. Additionally, atomic write assures that the write is performed in an all or nothing manner for two or more write operations.

The related art utilizes atomic write for Solid State Drives (SSD), and is realized by the flash translation layer (FTL) of the SSD.

Reducing the number of write operations to the flash memory improves the flash memory's endurance.

Assuring the all or nothing write operation by the FTL can ensure that the SSD does not overwrite the data in the write operation. However, storage systems do not presently have this feature. Therefore, the same methods utilized in the FTL cannot be applied to the storage system.

For example, many types of storage media can be installed in a storage system. Example of storage media installed in the storage system include SSDs supporting the atomic write operation, SSDs that do not support the atomic write operation, and Hard Disk Drives (HDDs). Related Art storage systems cannot determine which media supports the atomic write operation. Therefore, the atomic write operation is not utilized for related art storage systems.

### SUMMARY

Aspects of the present application may include a storage system, which may involve a storage device; and a controller with a cache unit. The controller may be configured to manage a status in which a first data and a second data corresponding to an atomic write command are stored in the cache unit, and a third data and a fourth data are maintained in the storage system, the third data being a previous data to be updated by the first data, and the fourth data being a previous data to be updated by the second data; and may be further configured to handle the atomic write command such that the status is maintained until the controller stores a plurality of data corresponding to the atomic write command in the cache unit.

Aspects of the present application may also include a method, which may involve managing a status in which a first data and a second data corresponding to an atomic write command are stored in a cache unit, and a third data and a fourth data are maintained in a storage system, the third data being a previous data to be updated by the first data, and the fourth data being a previous data to be updated by the second data; and handling the atomic write command such that the status is maintained until a plurality of data corresponding to the atomic write command is stored in the cache unit.

Aspects of the present application may also include a computer readable storage medium storing instructions for executing a process. The instructions may involve managing a status in which a first data and a second data corresponding to an atomic write command are stored in a cache unit, and a third data and a fourth data are maintained in a storage system, the third data being a previous data to be updated by the first data, and the fourth data being a previous data to be updated by the second data; and handling the atomic write command such that the status is maintained until a plurality of data corresponding to the atomic write command is stored in the cache unit.

### BRIEF DESCRIPTION OF THE DRAWINGS

FIG. 1 is a diagram of a server in a computer system in accordance with an example implementation.

FIG. 2 is a diagram of a storage system in a computer system in accordance with an example implementation.

FIG. 3 is a detailed block diagram of the storage control information in accordance with an example implementation.

FIG. 4 is a detailed block diagram of the storage program in accordance with an example implementation.

FIG. 5 is an example of the cache management table and the cache free queue in FIG. 3, in accordance with an example implementation.

FIG. 6 is an example of the related art atomic write operation process.

FIG. 7 is a conceptual diagram describing a first example implementation.

FIG. 8 is an example of the temporary cache table in accordance with the first example implementation.

FIG. 9 is an example of the first example implementation for the atomic write operation.

FIG. 10 is a conceptual diagram describing a second example implementation.

FIG. 11 is an example of the second example implementation for the atomic write operation.

FIG. 12 is a description of two types of cache areas, in accordance with a third example implementation.

FIG. 13 is an example of the cache management table for the third example implementation.

FIG. 14 is a conceptual diagram describing a third example implementation.

FIG. 15 is an example of the third example implementation for the atomic write operation.

FIG. 16 is an example of the storage system configuration which has both DRAM and flash memory as the cache unit, in accordance with a fourth example implementation.

FIG. 17 is an example of the cache free queues, in accordance with a fourth example implementation.

FIG. 18 is an example of the write processing which issues the atomic write command to the flash memory, in accordance with a fourth example implementation.

FIG. 19 is an example of the write program which integrates two or more write commands and writes these data by using one atomic write command, in accordance with a fifth example implementation.

### DETAILED DESCRIPTION

Some example implementations are described with reference to drawings. Any example implementations that are described herein do not restrict the inventive concept in accordance with the claims, and one or more elements that are described in the example implementations may not be essential for implementing the inventive concept.

In the following descriptions, the process is described while a program is handled as a subject in some cases. For a program executed by a processor, the program executes the predetermined processing operations. Consequently, the program being processed can also be a processor. The processing that is disclosed while a program is handled as a subject can also be a process that is executed by a processor that executes the program or an apparatus that is provided with the processor (for example, a control device, a controller, and a storage system). Moreover, a part or a whole of a process that is executed when the processor executes a program can also be executed by a hardware circuit as substitute for or in addition to a processor.

The instructions for the program may be stored in a computer readable storage medium, which includes tangible media such as flash memory, random access memory (RAM), HDD and the like. Alternatively, instructions may be stored in the form of a computer readable signal medium, which includes non-tangible media such as carrier waves.

Example implementations described herein are directed to protocols for facilitating an atomic write command in a storage system. The storage system may maintain a status where data corresponding to an atomic write command are stored in a cache unit for writing to the storage devices of the storage system, with old data being maintained in storage system. The status can be maintained until the processing of the data corresponding to the atomic write command to the cache unit is completed.

As atomic commands may involve one or more write locations to one or more storage devices, multiple data streams may be used in the atomic write command. In such a case, the cache unit is configured such that multiple data corresponding to the atomic write command is stored in the cache unit and the original old data across the one or more storage devices is maintained until processing of the multiple data streams to the cache unit is complete. After completion of such processing, the data may then be destaged to the storage devices.

By maintaining such a status for the storage system, the all or nothing feature of the atomic write command can be realized, because the old data in the storage system is not overwritten until processing of the data into the cache is complete. If the processing fails, then the write data stored in the cache can be discarded without being written to the storage devices of the storage system.

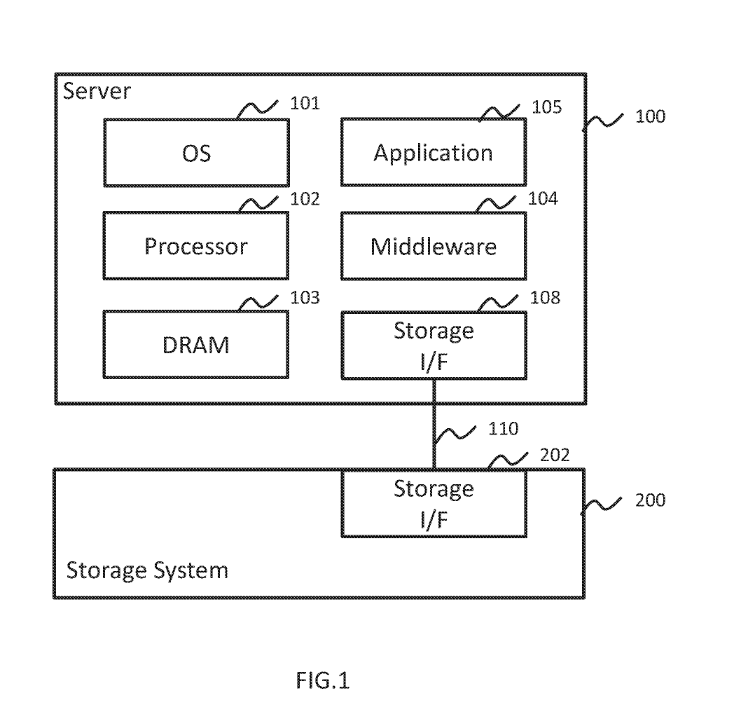

FIG. 1 is a diagram of a server in a computer system in accordance with the first example implementation. The computer system may include server 100 and storage system 200. The server may include Operating System (OS) 101, processor 102, Dynamic Random Access Memory (DRAM) 103, middleware 104, application 105 and storage interface (I/F) 108. The server 100 provides service by executing an OS and applications (e.g. a database system). The data processed by the database system is stored in the storage system 200. The server 100 is coupled to the storage system 200 via a network 110 and can communicate with the storage system 200 through a storage interface 202. The storage system 200 may be managed by a server controller (not illustrated), which can involve processor 102 and one or more other elements of the server, depending on the desired implementation.

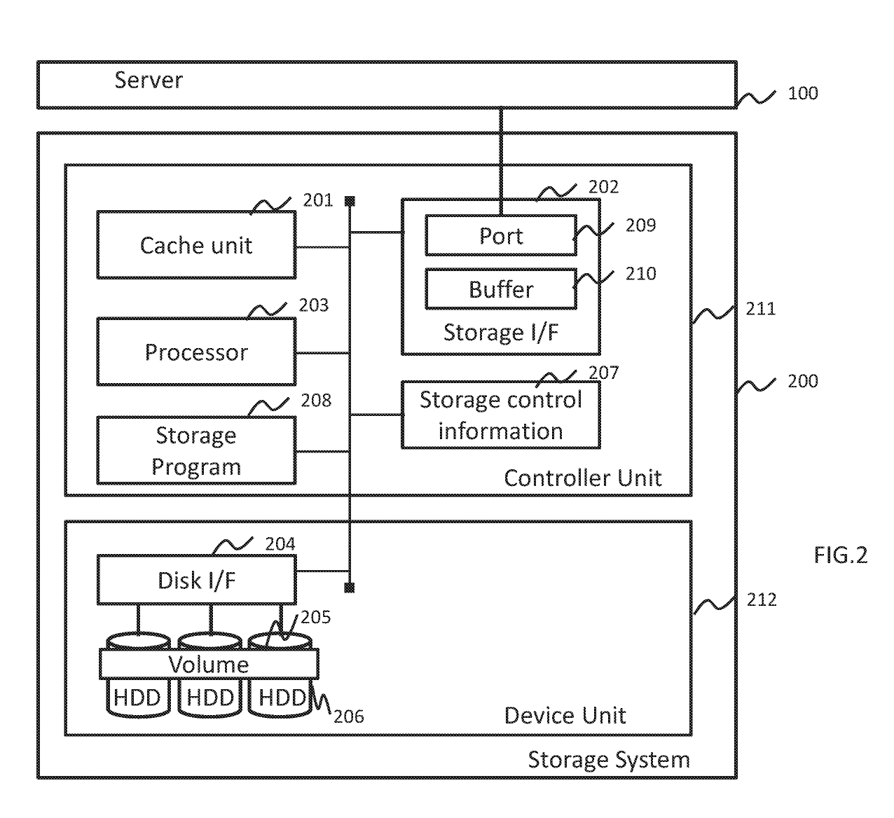

FIG. 2 is a diagram of a storage system in a computer system according to the first example implementation. The storage system contains one or more components that form a controller unit 211 (e.g., a storage controller) and one or more components that form a device unit 212 (e.g., storage unit). The storage system may include Storage I/F 202 having one or more ports 209, and a buffer 210. Port 209 is coupled to the server 100 via a network 110, and mediates a communication with the server 100. The buffer 210 is a temporary storage area to store the transfer data between the server 100 and the storage system 200.

Processor 203 executes processing by executing programs that have been stored into storage program 208. Moreover, the processor 203 executes processing by using information that has been stored in storage control information 207.

Disk I/F 204 is coupled to at least one HDD 206 as an example of a physical storage device via a bus. For example, a volume 205 that is configured to manage data is configured by at least one storage region of the HDD 206. The physical storage device is not restricted to an HDD 206 and can also be an SSD or a Digital Versatile Disk (DVD). Moreover, at least one HDD 206 can be collected in a unit of a parity group, and a high reliability technique such as a RAID (Redundant Array of Independent Disks) can also be used.

Storage control information 207 stores a wide variety of information used by a wide variety of programs. Storage program 208 stores a wide variety of programs, such as a read processing program or a write processing program. Cache unit 201 caches the data stored in HDD 206 in order to boost performance.

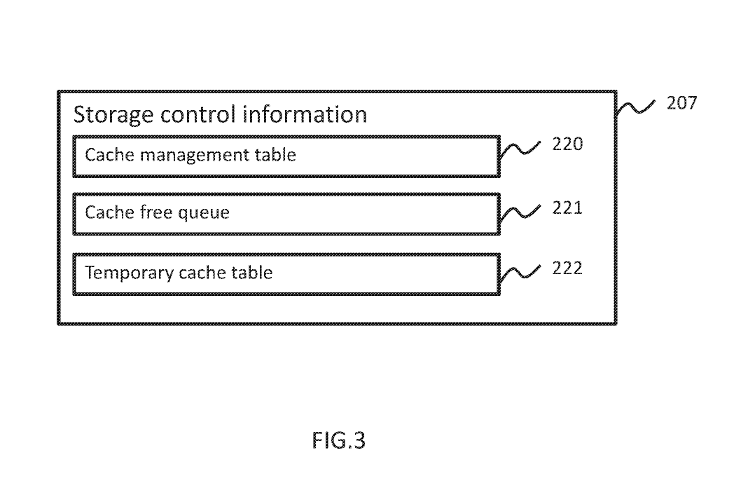

FIG. 3 is a detailed block diagram of the storage control information 207 according to the first example implementation. The storage control information 207 contains a cache management table 220, a cache free queue 221, and a temporary cache table 222. This storage control information 207 is used by programs in storage program 208. The cache management table 220 manages whether the data of the HDD is cached into a cache unit. If the data is cached, the address on the cache unit is also managed by this table. The cache free queue 221 manages the free area on the cache unit. The temporary cache table 222 manages the cache area for write data stored temporarily.

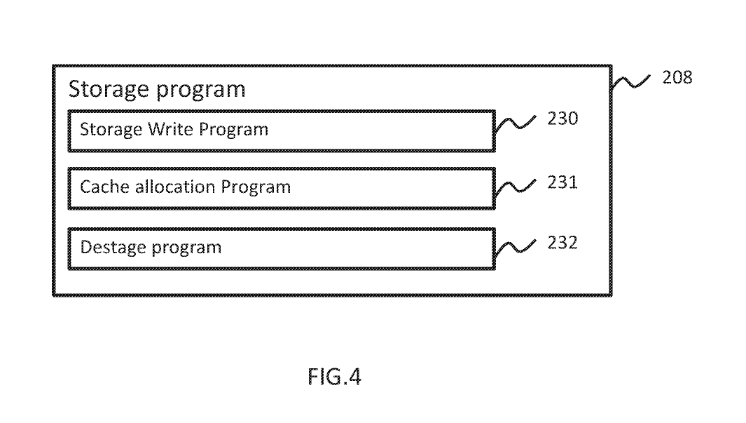

FIG. 4 is a detailed block diagram of the storage program 208 according to the first example implementation. The storage program 208 contains storage write program 230, cache allocation program 231 and destage program 232.

The storage write program 230 is a program to receive a write command from the server 100 and store the write data in the storage system. The cache allocation program 231 is a program to allocate a cache area for the read and write command from the server. The destage program 232 writes the data from the cache unit 201 to the HDD 206. The destage program 232 is called by other programs and executed periodically. As described above, the programs can contain instructions stored in a computer readable storage medium or a computer readable signal medium for execution by a processor or controller. Further details of these programs are described below.

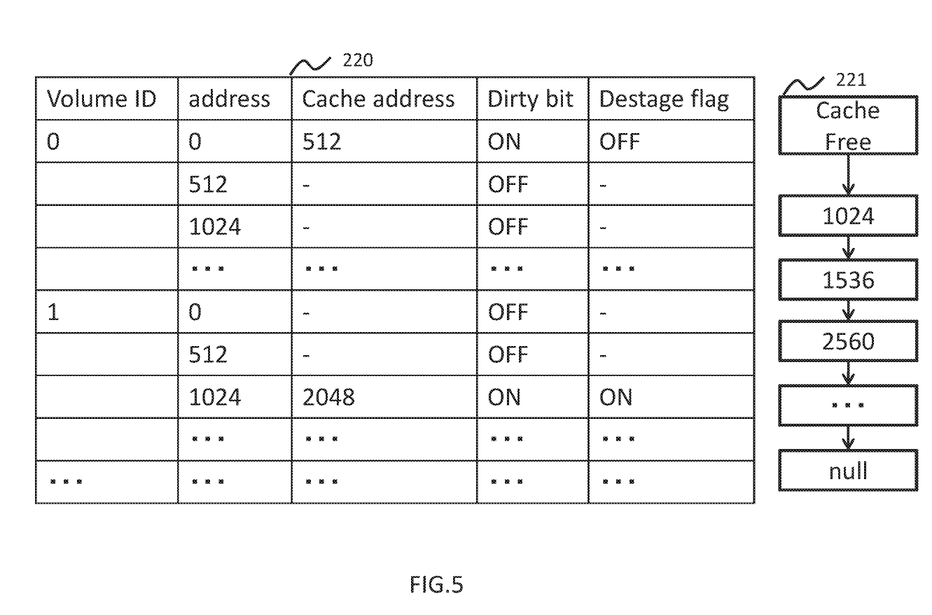

FIG. 5 is an example of the cache management table 220 and the cache free queue 221 in FIG. 3, in accordance with an example implementation. The Volume ID identifies the volume in the storage system. The address points to the partial area within the volume specified by the volume ID. The cache address manages the address on the cache unit 201. The data in the Volume ID and address columns is cached in the address. “-” indicates that the area specified by the volume ID and address is not cached. For example, the data stored in volume 0 and address 0 is cached in cache address 512. The Dirty bit is a flag to indicate whether the data on the cache unit 201 is dirty, i.e. data on the cache unit 201 that is not yet written to the HDD 206, or not.

The Destage flag is information for indicating whether that data on the cache unit 201 is to be destaged (e.g. written) to the HDD 206 or not. If the value of the destage flag is OFF, the data will not be written in HDD 206. On the contrary, if the value is ON, the data will be written in HDD 206 by destage program 232. In this example, the data is structured in a table. Generally, a tree structure is used for cache management. However, example implementations described herein are not limited to any particular data structure of the cache management, and other data structures known in the art may be substituted therefor.

Cache free” is at the head of the queue and indicates which caches are free. In this example, cache addresses 1024, 1536, 2560 and so on are free.

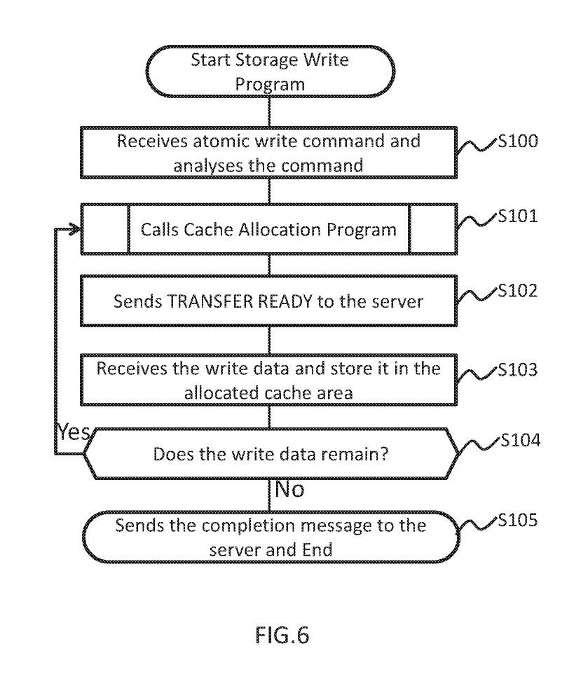

FIG. 6 is an example of the existing atomic write operation process. The storage write program receives an atomic write command from the server and analyzes the command (S100). The command contains a write target addresses list, an atomic bit and so on. If the atomic bit is ON, the write command is the atomic write command. If the value is OFF, the write command is a regular write command.

Then, the program calls the cache allocation program to allocate the area for preparing the cache area (S101). After that allocation, the program notifies the server 100 that the storage system can receive the write data (S102). Then, the program receives the write data and stores the write data in the allocated cache area (S103). Next, the program confirms whether un-transferred write data remains in the server (S104). This confirmation can be realized by using the write data length information received in first step. If the write data remains, the program returns to S101. If the write data does not remain, the program sends the completion message to the server 100 and terminates the processing (S105).

If all the write data of the atomic write command could not be transferred because of the server, network switch, or cable failure, a part of the write data of the atomic write command which is already written to the cache area should be deleted.

However, a portion of the write data may have overwritten old data. When this is the case, deletion of only a portion of the write data is difficult. Besides situations involving the failure of the server, network, or cable, there are also situations in which the data cannot be written in the cache area or HDD in the storage system due to various other obstacles known in the art. Furthermore, after writing a portion of the write data, there are situations in which the server directs cancellation.

Described below are three example implementations to assure the application of the all or nothing feature of the atomic write.

First Example Implementation

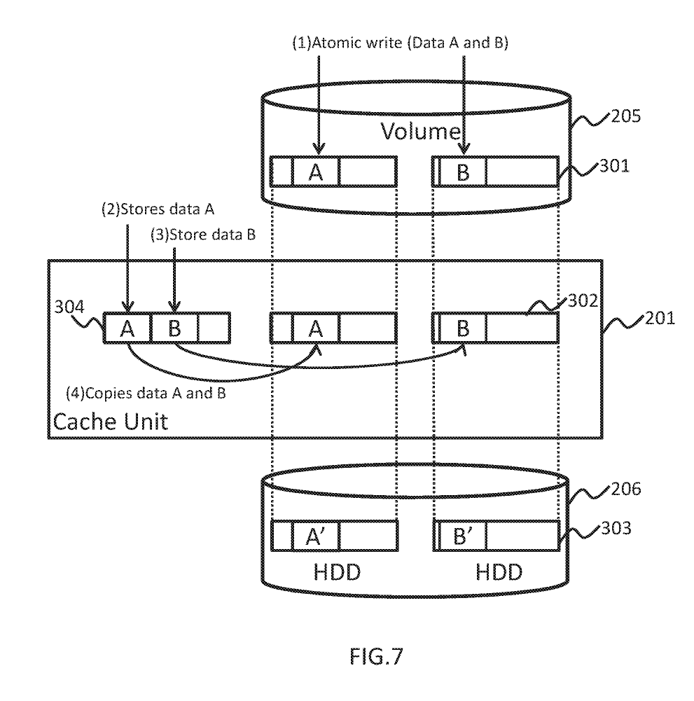

In a first example implementation, methods are utilized to assure the all or nothing feature of the atomic write operation. In particular, cache memory installed in the storage system is utilized as described below. The first example implementation is described in FIGS. 7, 8 and 9.

FIG. 7 is a conceptual diagram describing the first example implementation. Volume 205, cache unit 201, and HDD 206 are the same as in FIG. 2. The volume is a logical element. Cache unit 201 and HDD 206 are physical elements. Elements 301, 302 and 303 are mutually corresponding partial areas. Element 304 is a temporary cache area.

In the first example implementation, an atomic write command containing write data A and B is issued to the partial areas 301. The storage system receives data A from the server, allocates a temporary cache area, and stores data A to the allocated temporary cache area. The storage system does not store the write data A to the partial cache area 302, to avoid overwriting old data. In this example, the old data of A is indicated as A′. Then, the storage system receives data B from the server and stores data B to the temporary cache area in a similar manner as data A. After receiving write data A and B, the write data A and B are copied from temporary cache area 304 to the cache area 302.

When a part of the write data of the atomic write command cannot be written to the cache or cannot be transferred from the server due to failure, the write data already received can be deleted by releasing the temporary cache area. Therefore, the all or nothing feature of the atomic write command can be realized.

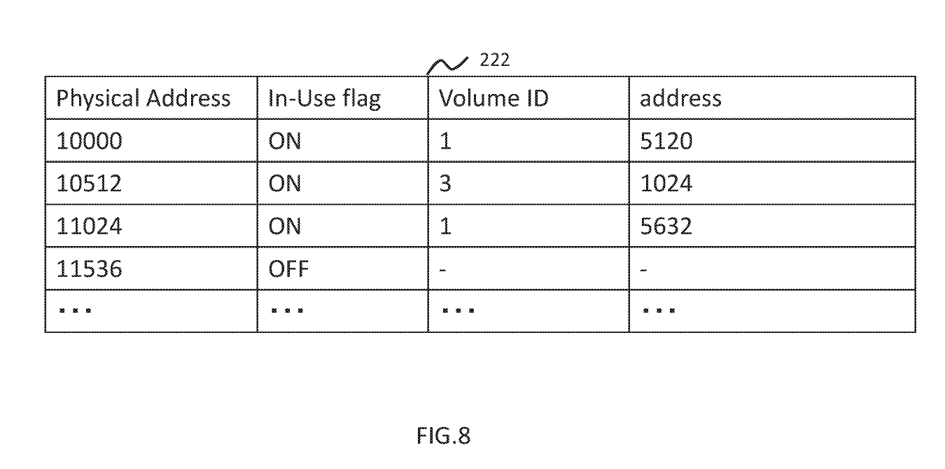

FIG. 8 is an example of the temporary cache table 222, in accordance with an example implementation. The temporary cache table 222 manages a part of the cache unit 201 which is assigned as a temporary area. The Physical Address is an address of a cache area assigned as a temporary area. The In-Use flag manages whether the area specified by the physical address is in use or not. The meaning of the Volume ID and address is the same as these elements in FIG. 5. A valid value is stored in Volume ID and address only when the In-Use flag is “ON”.

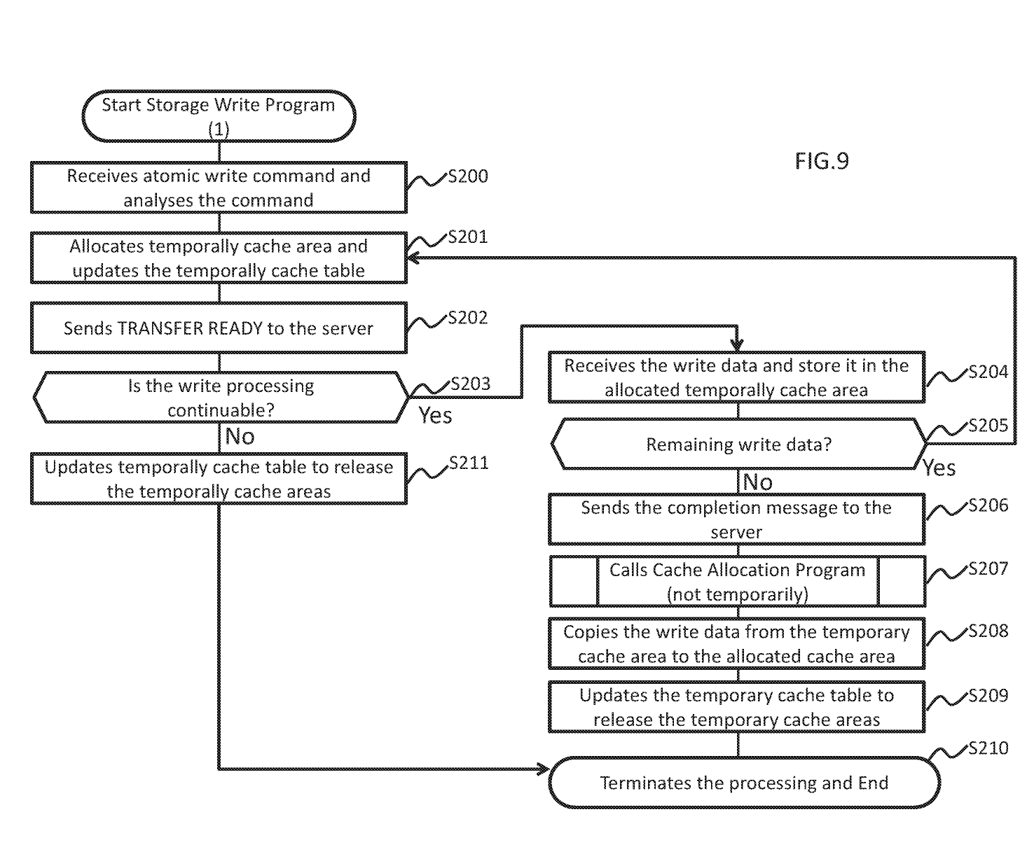

FIG. 9 is an example of the first example implementation for the atomic write operation. The Storage Write Program (1) receives an atomic write command from the server and analyzes the command (S200), in a similar manner to S100 in FIG. 6. The program allocates the temporary cache area 304 and updates the temporary cache table 222 (S201). In particular, the In-Use flag is changed to “ON” and the write target address is recorded in the Volume ID and address fields. The write target address is included in the write command.

After the allocation, the program notifies the server 100 that the storage system can receive the write data (S202). Next, the program decides whether the write processing can be continued or not (S203). For example, the condition for the decision is “No” if the next data is not transferred over the predetermined period, then the cancellation of the write command is received, and/or write data cannot be written due to the failure of the storage resource. If the result of S203 is “No,” the program updates the temporary cache table to release the allocated temporary cache area 304 (S211). The write data is not written to the volume because the copy operation from the temporary cache areas 304 to the cache area 302 is not executed.

If the result of S203 is “Yes”, the program progresses to S204. The program receives the write data and stores it in the allocated temporary cache area 304 (S204). Next, the program confirms whether un-transferred write data remains in the server (S205). If the result of S205 is “Yes”, the program returns back to S201 and repeats the process for the next write data.

If the result of S205 is “No”, then the result indicates that all write data is stored in the temporary cache area 304. Therefore, the program starts to copy the write data to the cache area 302 corresponding to the volume. First, the program sends the completion message to the server and calls the cache allocation program to allocate cache areas 302 corresponding to the volume (S206, S207). In the example in FIG.7, two cache areas 302 are allocated. After allocation of the cache areas 302, the program copies the write data from the temporary cache area 304 to the allocated cache area 302 (S208).

By copying the write data, the temporary cache area 304 will no longer be required. Thus, the program updates the temporary cache table to release the allocated temporary cache area 304 (S209). The In-Use flag is set to “OFF” and the volume ID and address is set to “-”. Then, the program terminates the processing (S210).

Second Example Implementation

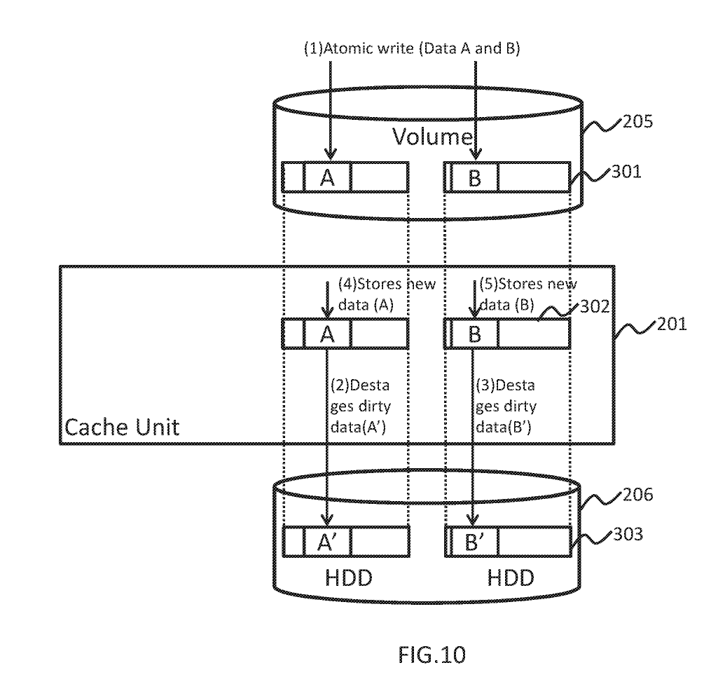

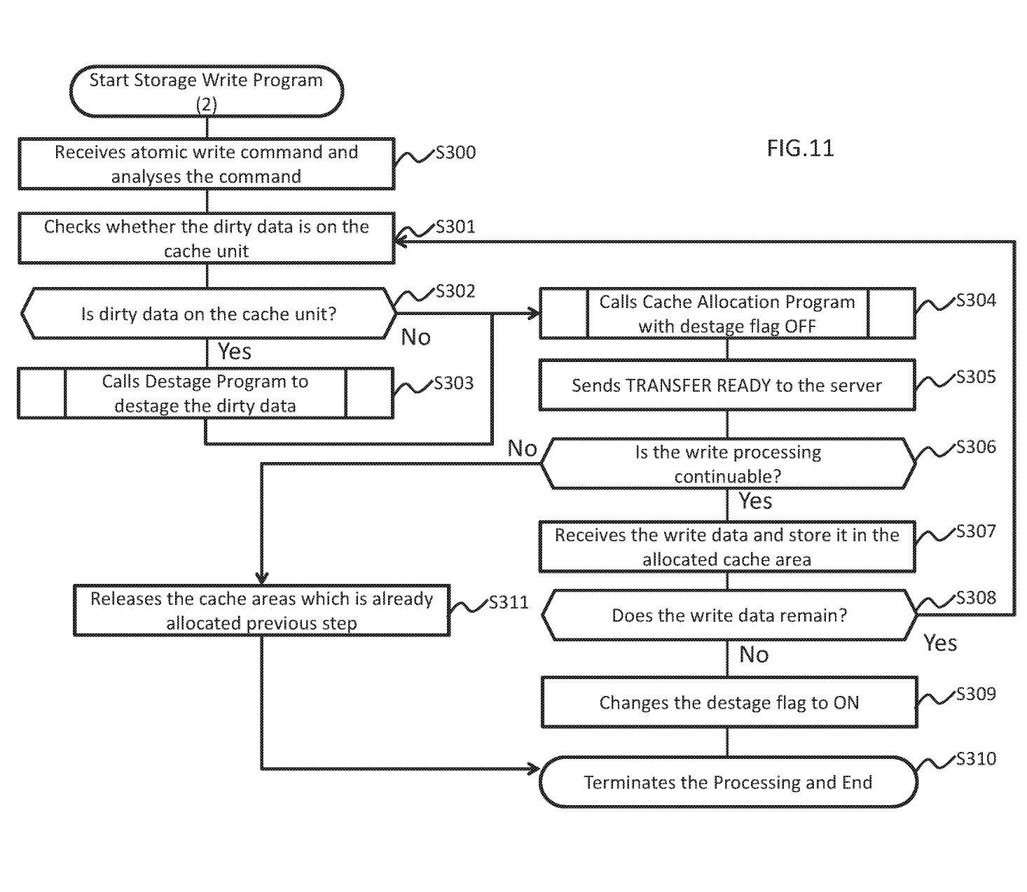

The second example implementation is directed to methods to utilize the atomic write operation efficiently in the storage system, and is described in FIGS. 10 and 11.

FIG. 10 is a conceptual diagram describing the second example implementation. The receiving of the atomic write containing write data A and B is the same as in FIG. 7 as described above. After receiving the write command, the storage system destages the old data A′ and B′ to the partial area 303 to avoid overwriting old data. Then, the storage system receives write data A and B from the server and stores it to the cache area 302 corresponding to the volume.

When a part of the write data of atomic write cannot be written to the cache or cannot be transferred from the server due to failure and so on, the write data already received can be deleted by releasing the cache area 302, because the old data is not included in the cache area 302. However, there is a possibility that the data A may be written in HDD 206 before receipt of the data B. In this case, old data A may be overwritten. To avoid this overwriting, the second example implementation defers the destaging of the data A until reception of the data B. Thus, the all or nothing feature of the atomic write command can be realized.

FIG. 11 is an example of the second example implementation for the atomic write operation. First, the storage write program (2) receives an atomic write command from the server and analyses the command (S300) in a similar manner to S100 in FIG. 6. The write program checks whether the dirty data is on the cache unit 201 or not (S301 and S302). If the dirty data is on the cache unit 201, the program calls the destage program to destage the dirty data (S303) and waits for completion. This completion means completion of the copying from cache unit 201 to the HDD 206. On the contrary, if the dirty data is not on the cache unit 201, the program skips S303 and progresses to S304.

The program calls the cache allocation program to allocate cache area (S304). At this allocation, the cache management table 220 is updated. At the update, the program sets the value in the destage flag field to “OFF”. If the value of the destage flag is “OFF,” the destage program doesn't execute the destage processing for the data. Therefore, the destaging of data A before receiving data B in FIG. 10 can be avoided.

After that allocation, the program notifies the server 100 that the storage system can receive the write data (S305). Next, the program decides whether the write processing can be continued or not (S306) in a similar manner to S203 in FIG. 9.

If the result of step S306 is “Yes,” the program progresses to S307, wherein the program receives the write data and stores it in the allocated cache area 302 (S307). Next, the program confirms whether un-transferred write data remains in the server (S308), in a similar manner as S205 in FIG. 9. If the result of S308 is “Yes,” the program returns back to S302 and executes the above process for the next write data. If the result of S308 is “No,” it means that receiving of all the data is completed. So, the program changes the destage flag to “ON” to cancel the avoidance of the destage (S309). Finally, the program sends the completion message to the server and terminates the processing (S310).

If the result of S306 is “No,” the program releases the cache areas which are already allocated for this atomic write operation from S311. All write data are not written to the volume because the destage of the write data is not executed.

Third Example Implementation

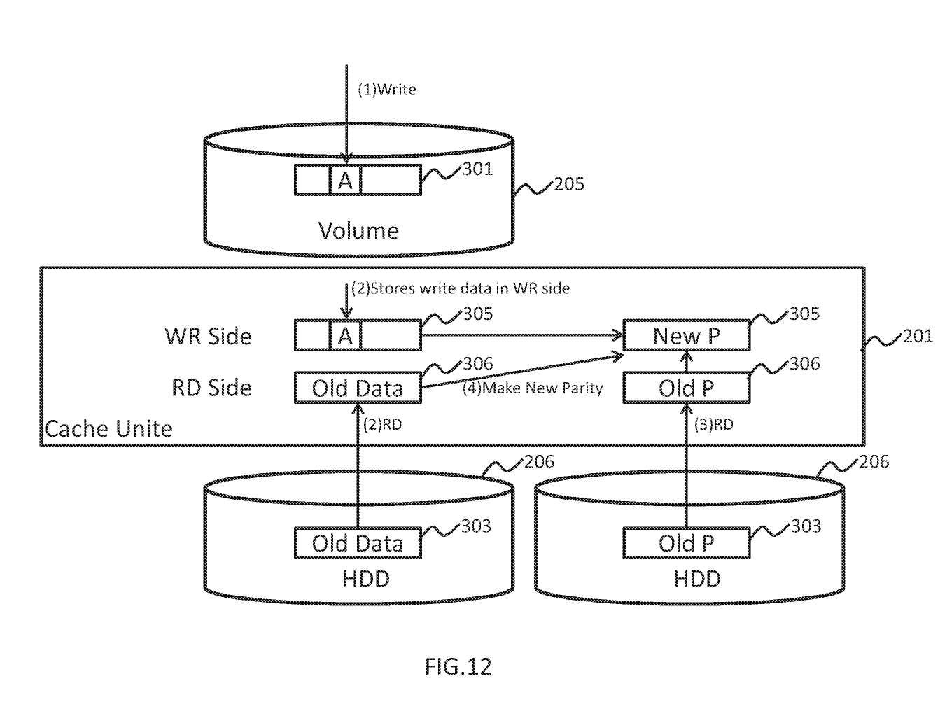

The third example implementation is described in FIGS. 12, 13, 14 and 15. In the explanation of the first and second example implementations, the one cache area 302 corresponds to the one partial area 301 in volume and the one partial area 303 in the HDD 206. However, the storage system may have two types of the cache area for one partial area 301 or 303. The third example implementation is directed to the utilization of two types of cache areas.

FIG. 12 is a description of two types of cache areas, in accordance with the third example implementation. Almost all elements in FIG. 12 are the same as elements in FIGS. 7 and 10. The differences are the elements of a write side cache area 305 and a read side cache area 306 (hereinafter write side 305 and read side 306).

Write side 305 is used to store the write data written from the server. Read side 306 is used to store the old data. In FIG. 12, the old data is the data before writing the data A. The necessity of storing the old data is described below.

With the use of RAID-5 technology, new parity data is calculated after writing the data. Generally, new parity data is calculated from new data (data A), old data and old parity data. Therefore, read side 306 is used to store the old data which is read from the HDD 206. Read side 306 is also used to store the old parity data. The third example implementation leverages these two types of cache area.

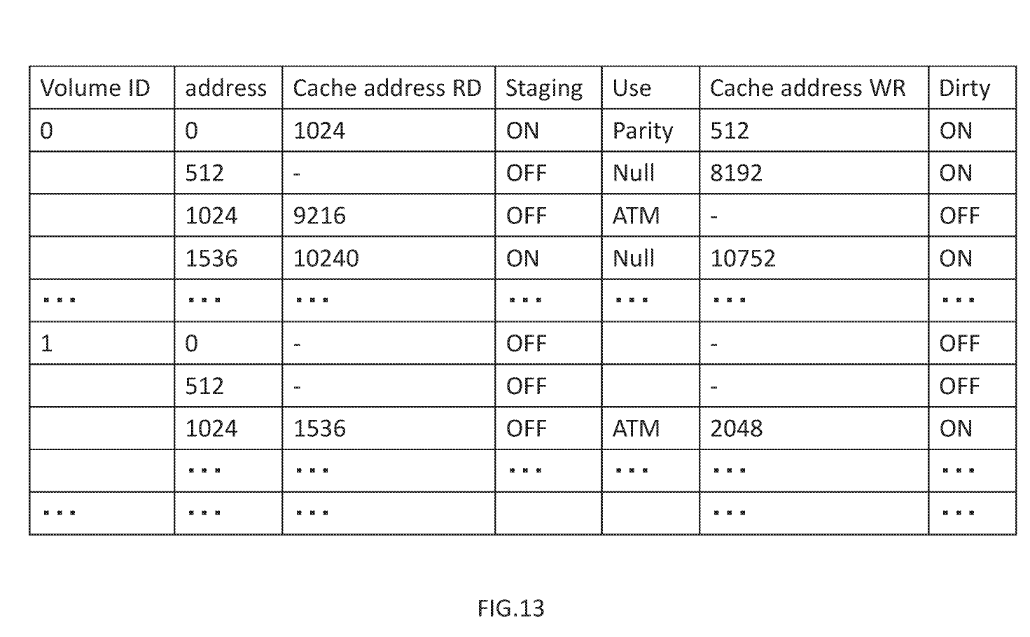

FIG. 13 is an example of the cache management table for the third example implementation. The cache management table has the cache address RD and the cache address WR instead of the cache address in FIG. 5. The cache address RD manages the address of the read side 306 and the cache address WR manages the address of the write side 305.

The staging field and the use field are added. If the staging is “ON,” the data of HDD 206 is done staging to the read side 306. The staging status can be managed with smaller granularity than that of cache allocation by using bitmap structure instead of flag.

The use field manages use of the read side. If the use field is “Parity,” the parity making processing is using the read side 306. If the use field is “ATM,” the atomic write operation is using the read side 306. If the use field is “null,” there is no processing using the read side 306. By using this information, erasure of the atomic write data by read processing (staging) of the old data and incorrect parity calculation from the write data of the atomic write command can be avoided for parity making and atomic write.

In the example of FIG. 13, the parity calculation is being executed for the data of volume 0 and address 0. So, use of the read side 306 of volume 0 and address 0 by the atomic write is prevented until completion of parity calculation. For the data of volume 0 and address 512, the dirty data is managed and read side 306 is not used for parity calculation or atomic write. For the data of volume 0 and address 1024, read side 306 is used or the atomic write. So, use of read side 306 of volume 0 and address 1024 by the parity calculation is prevented until the completion of the atomic write.

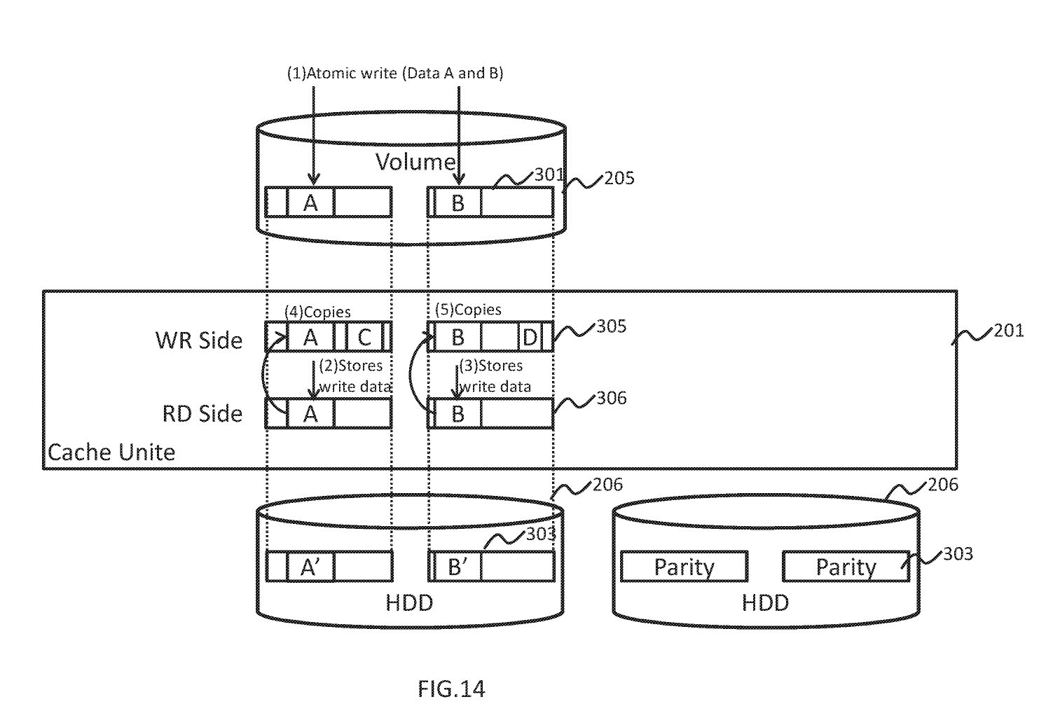

FIG. 14 is a conceptual diagram describing the third example implementation. Receipt of the atomic write containing write data A and B is the same as in FIG. 7. After receiving the write command, the storage system receives write data A and stores it in the read side 306 corresponding to the write target area of write data A. Then, the storage system receives write data B and stores it in the read side 306 corresponding to the write target area of write data B. By writing to the read side 306, overwriting of the old data can be avoided. After storing all write data contained in the atomic write command, the write data in the read side 306 are copied from the read side 306 to the write side 305. When a part of the write data of atomic write cannot be written to the cache or cannot be transferred from the server due to failure and so on, the write data which is already received can be removed by changing the use field to “null”.

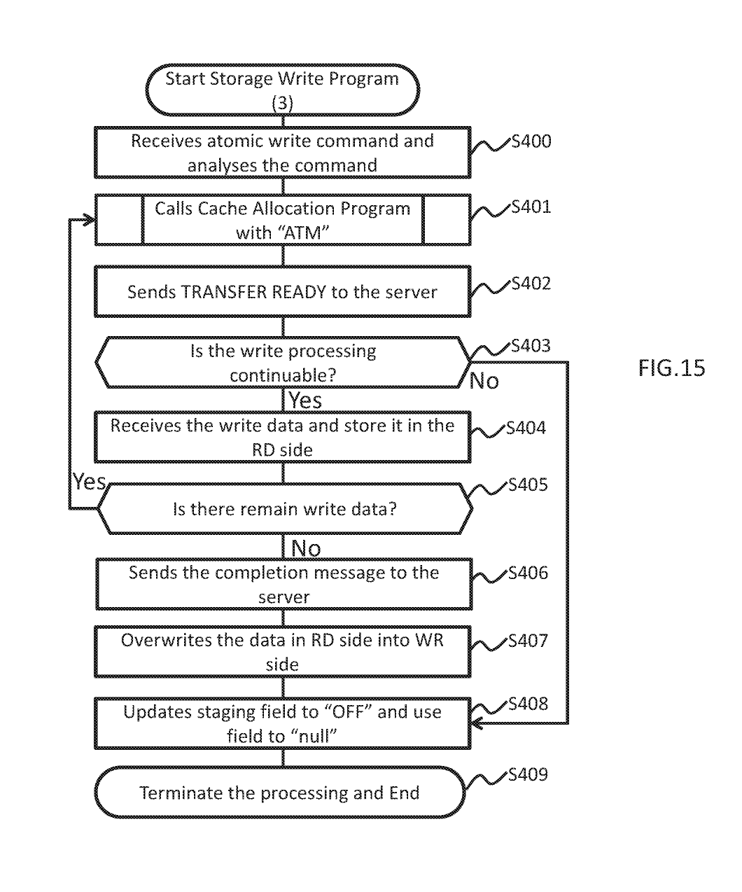

FIG. 15 is an example of the third example implementation for the atomic write operation. First, the storage write program (3) receives the atomic write command from the server and analyses the command (S400), in a similar manner as S100 in FIG. 6 as described above. Then, the program calls the cache allocation program to allocate cache areas (S401). This cache area is a read side 306 and a write side 305. In this allocation processing, the cache allocation program checks the use field. If the use field is “Parity”, then the program waits for the completion of the parity processing. In particular, the program waits for the use field to change to “null”. In this allocation, the cache management table is updated. At the update, the cache allocation program sets the value to “OFF” in the staging field and sets the value to “ATM” in the use field. By setting the value to “ATM,” the overwriting of the write data of the atomic write operation by the read old data processing operation is avoided. After that allocation, the program notifies the server 100 that the storage system can receive the write data (S402).

Next, the program decides whether the write processing can be continued or not (S403), in a similar manner to S203 in FIG. 9. If the result of S403 is “Yes,” the program progresses to S404. The program receives the write data and stores the write data in the allocated read side 306 (S404). Next, the program confirms whether un-transferred write data remains in the server (S405), in a similar manner as S205 in FIG. 9. If the result of S405 is “Yes,” the program returns back to S401 and executes the above process for the next write data. If the result of S405 is “No,” it means that all the data has been received. The program sends the completion message to the server (S406).

Then, the program copies the write data from the read side 306 to the write side 305 (S407). The program updates the cache management table. In particular, it changes the staging field to “OFF” and the use field to “null” (S408). The changing of the staging field is to avoid the write data of the atomic write operation being used as old data for parity calculation. The changing of the use field is to cancel exclusion of parity calculation and atomic write. Finally, the program terminates the processing (S409).

Differences between the first example implementation and the third example implementation are described below. The first example implementation allocates a size (e.g., predetermined) of temporary cache area beforehand. Also, the first example implementation may require more cache area than the third example implementation because the temporary cache area has both a read side and a write side. Moreover, the first example implementation may require management information and a program to manage the temporary cache area.

Fourth Example Implementation

There are many technologies which use the flash memory as cache unit 201. These technologies include the configuration which installs both DRAM and flash memory as cache unit 201. In a fourth example implementation, the methods that may improve the endurance and performance of the flash memory 401 are installed in the storage system. Non-atomic write commands are processed by the DRAM, while atomic write commands are processed by the flash memory.

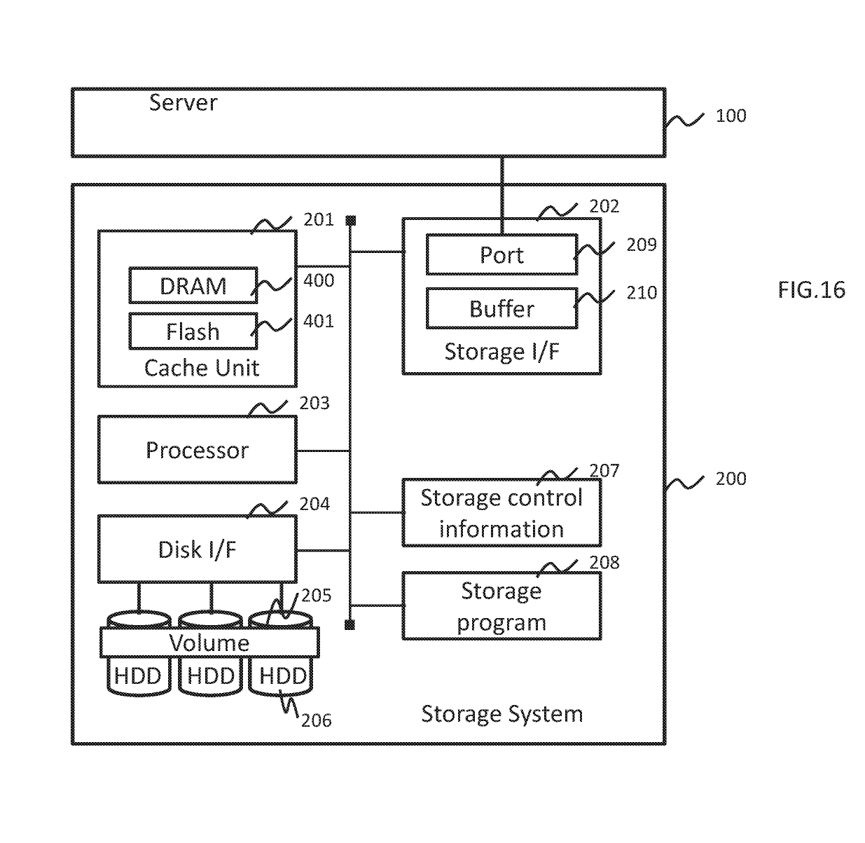

FIG. 16 is an example of the storage system configuration which has both DRAM 400 and flash memory 401 as cache unit 201. The flash memory 401 supports the atomic write command. If the storage system does not distinguish between DRAM 400 and flash memory 401, the atomic write feature of the flash memory 401 cannot be leveraged. In particular, the storage system may assign DRAM 400 to an atomic write if protocols are set for handling the atomic write feature in DRAM. In such a case, the performance and endurance can be improved by the storage system preferentially assigning flash memory to the atomic write command and DRAM to non-atomic write commands. To improve the endurance and performance, the storage system may use DRAM 400 and flash memory 401. Two cache free queues may be used to manage these memories 400, 401.

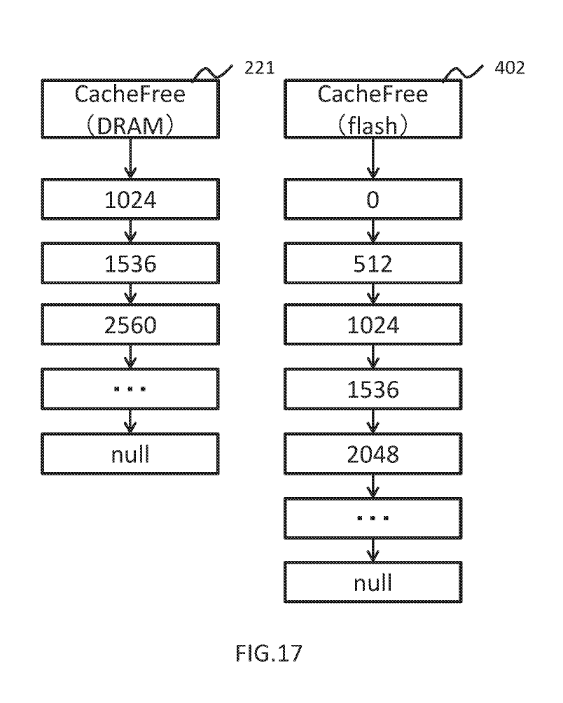

FIG. 17 is an example of the cache free queues, in accordance with a fourth example implementation. Cache free queue 221 manages free area on the DRAM 400. Cache free queue 402 manages free area on the flash memory 401. The area in the DRAM and the area in the flash memory have the same address because DRAM 400 differs from the flash memory 401 physically. The flag to distinguish DRAM 400 or flash memory 401 is added to the cache management table.

When the server receives the atomic write command, the flash memory 401 which supports the atomic write command allocates the cache area. The storage system issues the atomic write command to flash memory 401, thereby avoiding the requirement to execute the processing described in the first example implementation. Moreover, the performance and endurance of the flash memory 401 may be improved.

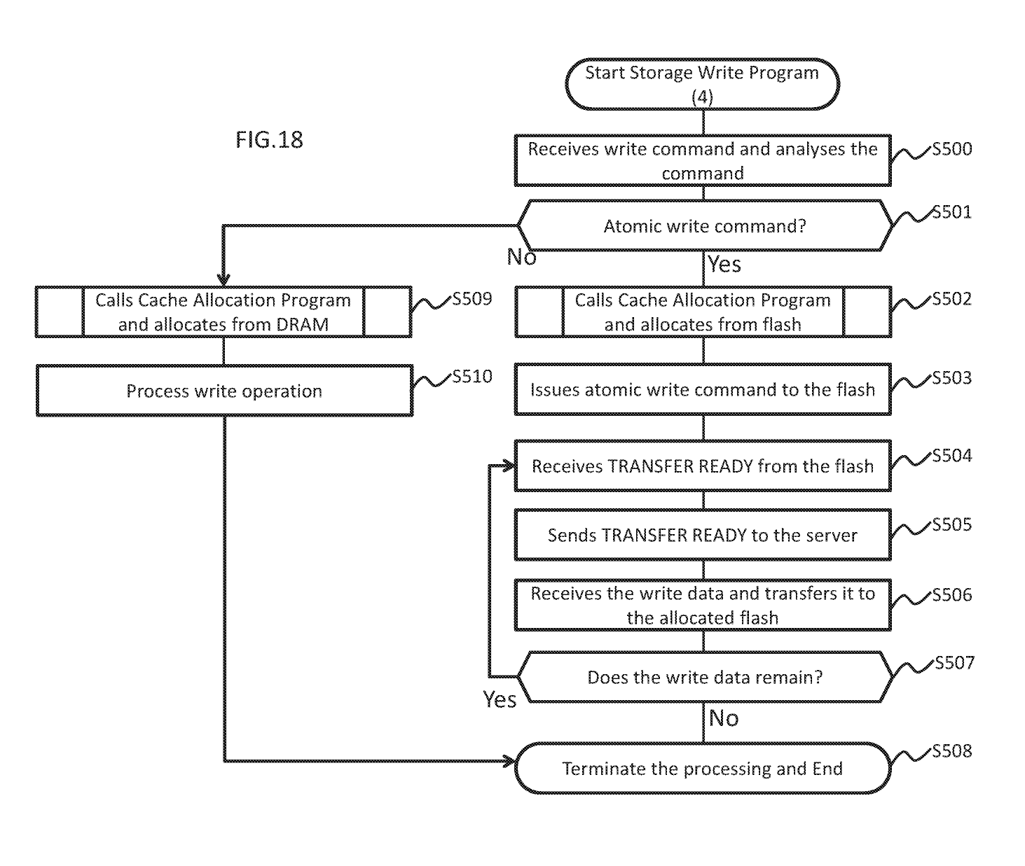

FIG. 18 is an example of the write processing which issues the atomic write command to the flash memory 401, in accordance with the fourth example implementation. First, the storage write program (4) receives the write command from the server and analyses the command (S500). Then, the program checks whether the write command is an atomic write command or not (S501).

If the result of S501 is “No,” the program calls the cache allocation program to allocate cache area from the DRAM 400 (S509). The program then executes the write operation for processing a non-atomic write command (S510). After that, the program progresses to S508 to send the completion message and terminate the processing. If the result of S501 is “Yes,” the program calls the cache allocation program to allocate cache area from the flash memory 401 (S502). This processing allocates the cache area for all the write data of the write command. After the cache allocation, the program issues atomic write to the flash memory 401 (S503). Then, the program receives a “transfer ready” indication from the flash memory 401 (S504) and sends the “transfer ready” indication to the server (S505). Next, the program receives the write data from the server and stores the write data in the allocated flash memory 401 (S506). Accordingly, the storage system transfers the write data to the flash memory 401. After the transfer, the program confirms whether un-transferred write data remains in the server (S507). If the result of S507 is “Yes,” the program returns to S504 and executes the above process for the next write data. If the result of S507 is “No”, it means that all the data has been received. So, the program sends the completion message to the server and terminates the processing. Thus, the all or nothing feature is realized by the flash memory 401.

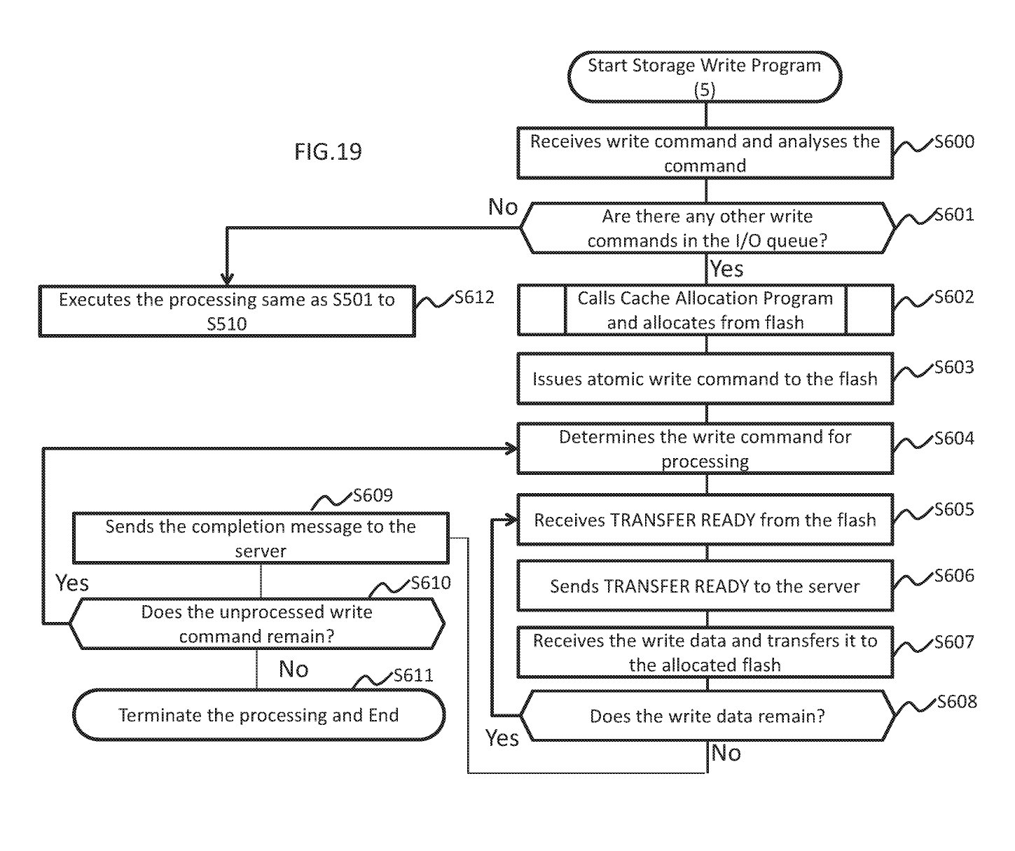

FIG. 19 is an example of the write program which integrates two or more write commands and writes these write data by using one atomic write command, in accordance with a fifth example implementation. With the dual use of DRAM and flash memory, the write data of two or more non-atomic write commands can be integrated together to form an atomic write command, and the integrated write data can be transferred to flash memory 401 by using the formed atomic write command.

First, the storage write program (5) receives the write command and analyses the command (S600). More specifically, the storage write program (5) is called from the kernel and obtains from the write command request from the I/O queue. Then, the program confirms whether there are any other write commands in the I/O queue (S601). If the result of S601 is “No,” the program executes the processing the same manner as in S501 to S510 in FIG. 18 (S612). If the result of S601 is “Yes,” the program calls the cache allocation program to allocate cache area from the flash memory 401 (S602). This processing allocates the cache area for all write commands.

After the cache allocation, the program forms and issues an atomic write command to the flash memory 401 (S603). The program determines the write command for processing (S604) and executes the following step for the determined write command. The program receives a “transfer ready” indication from the flash memory 401 (S605) and sends the “transfer ready” indication to the server (S606). The program receives the write data from the server and stores the write data in the allocated flash memory 401 (S607), thereby performing the transferring the write data to the flash memory 401.

After the transfer, the program confirms whether un-transferred write data remains in the server (S608). If the result of S608 is “Yes,” the program returns to S605 and executes the above process for the next write data. If the result of S608 is “No,” it means that receiving of the all write data of the determined write command at the S604 is completed. Accordingly, the program sends the completion message to the server. Then, the program confirms whether any unprocessed write commands remain in the write command list obtained in S601.

If the result of S610 is “Yes,” the program returns to S604.The program determines the next write command for processing and executes S605 to S609 to the determined next write command. Eventually, the result of S610 will be “No,” and the program terminates the processing (S611).

Some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the example implementations, the steps carried out require physical manipulations of tangible quantities for achieving a tangible result.

Moreover, other implementations of the present application will be apparent to those skilled in the art from consideration of the specification and practice of the example implementations disclosed herein. Various aspects and/or components of the described example implementations may be used singly or in any combination. It is intended that the specification and examples be considered as examples, with a true scope and spirit of the application being indicated by the following claims.

What is claimed is:

1. A storage system, comprising:
one or more storage devices configured to provide a plurality of logical areas;
a cache memory; and
a processor, configured to, for receipt of a write command to write first data to a first address of a first logical area of the plurality of logical areas and second data to a second address of either the first logical area or a second logical area of the plurality of logical areas:
for third data stored in the cache memory as first dirty data of the first address, destage the third data to the one or more storage devices;
store the first data to the cache memory as the first dirty data of the first address after the third data is destaged;
store the second data to the cache memory as second dirty data of the second address; and
set the first data and the second data to be destaged from the cache memory after completion of the storage of the first data and the second data to the cache memory.

2. The storage system of claim 1, wherein the processor is configured to:
for fourth data stored in the cache memory as the second dirty data of the second address, destage the fourth data to the storage devices; and
wherein the store of the second data to the cache memory as the second dirty data of the second address is conducted after the fourth data is destaged.

3. The storage system of claim 1, wherein the processor is configured to:
for an occurrence of failure of storage of a portion of either the first data or the second data to the cache memory, delete received portions of the first data and the second data from the cache memory.

4. The storage system of claim 1, wherein the write command is an atomic write command.

5. The storage system of claim 1, wherein the processor is configured to:
determine whether fourth dirty data is stored in the cache memory as the second dirty data of the second address,
for a determination that the fourth data is stored in the cache memory as the second dirty data of the second address, destage the fourth data to the storage devices and conduct the store of the second data to the cache memory as the second dirty data of the second address after the fourth data is destaged;
for a determination that the fourth data is not stored in the cache memory as the second dirty data of the second address, conduct the store of the second data to the cache memory as the second dirty data of the second address.

6. The storage system of claim 1, wherein the processor is configured to allocate cache area for the store of the first data and the second data in the cache memory.

7. The storage system of claim 6, wherein the processor is configured to update a cache management table after the cache area is allocated.

8. The storage system of claim 1, wherein the write command is received from a server, wherein upon allocation of cache area in the cache memory for the store of the first data and the second data, the processor is configured to instruct the server to transmit the first data and the second data;
wherein the processor is configured to send a completion message to a server upon completion of the store of the first data and the second data to the cache memory.

9. The storage system of claim 1, wherein the processor is configured to:
for an occurrence of failure of storage of a portion of either the first data or the second data to the cache memory, release cache areas allocated for the storage of the first data and the second data in the cache memory.

10. The storage system of claim 1, wherein the processor is configured to analyze the write command as either an atomic write command or a regular write command.

11. A method for managing a storage system having one or more storage devices configured to provide a plurality of logical areas, and a cache memory, the method comprising:
for receipt of a write command to write first data to a first address of a first logical area of the plurality of logical areas and second data to a second address of either the first logical area or a second logical area of the plurality of logical areas:
for third data stored in the cache memory as first dirty data of the first address, destaging the third data to the one or more storage devices;
storing the first data to the cache memory as the first dirty data of the first address after the third data is destaged;
storing the second data to the cache memory as second dirty data of the second address; and
setting the first data and the second data to be destaged from the cache memory after completion of the storage of the first data and the second data to the cache memory.

12. The method of claim 11, wherein the processor is configured to:
for fourth data stored in the cache memory as the second dirty data of the second address, destaging the fourth data to the storage devices; and
wherein the storing of the second data to the cache memory as the second dirty data of the second address is conducted after the fourth data is destaged.

13. The method of claim 11, further comprising:
for an occurrence of failure of storage of a portion of either the first data or the second data to the cache memory, deleting received portions of the first data and the second data from the cache memory.

14. The method of claim 11, wherein the write command is an atomic write command.

15. The method of claim 11, further comprising:
determining whether fourth dirty data is stored in the cache memory as the second dirty data of the second address,
for a determination that the fourth data is stored in the cache memory as the second dirty data of the second address, destaging the fourth data to the storage devices and conducting the storing of the second data to the cache memory as the second dirty data of the second address after the fourth data is destaged;
for a determination that the fourth data is not stored in the cache memory as the second dirty data of the second address, conducting the storing of the second data to the cache memory as the second dirty data of the second address.

16. The method of claim 11, further comprising allocating cache area for the storing of the first data and the second data in the cache memory.

17. The method of claim 16, further comprising updating a cache management table after the cache area is allocated.

18. The method of claim 11, wherein the write command is received from a server, wherein upon allocation of cache area in the cache memory for the store of the first data and the second data, instructing the server to transmit the first data and the second data; and
sending a completion message to a server upon completion of the store of the first data and the second data to the cache memory.

19. The method of claim 11, further comprising:
for an occurrence of failure of storage of a portion of either the first data or the second data to the cache memory, releasing cache areas allocated for the storage of the first data and the second data in the cache memory.

20. The method of claim 11, wherein the processor is configured to analyze the write command as either an atomic write command or a regular write command.
